(19) United States
(12) Patent Application Publication
(10) Pub. No.: US 2014/0226571 A1
(43) Pub. Date: Aug. 14, 2014

(54) APPARATUS AND METHOD FOR ENHANCED APPLICATION COEXISTENCE ON AN ACCESS TERMINAL IN A WIRELESS COMMUNICATION SYSTEM

(71) Applicant: QUALCOMM INCORPORATED, San Diego, CA (US)

(72) Inventors: Soumya DAS, San Diego, CA (US); Bongyong SONG, San Diego, CA (US); Yuheng HUANG, San Diego, CA (US)

(73) Assignee: QUALCOMM Incorporated, San Diego, CA (US)

(21) Appl. No.: 13/766,347

(22) Filed: Feb. 13, 2013

(51) Int. Cl. H04W 28/20

(52) U.S. Cl. CPC H04W 28/20
USPC 370/329

(57) ABSTRACT

Apparatus and methods are disclosed for dynamically allocating an available bandwidth among different applications running at an access terminal operating in a wireless communication system that may be subject to certain bandwidth constraints. In particular, management of the allocation of resources when such resources are determined to be constrained may be implemented at the access terminal itself, for example, by reducing a requested bandwidth corresponding to at least one application flow from among a plurality of application flows. In this way, the superior information available to the access terminal regarding the demands and capabilities of the individual applications can be taken into account. Thus, multiple concurrently running applications competing for common limited resources may achieve a satisfactory level of service or QoS, resulting in an enhanced user experience.

### TECHNICAL FIELD

Aspects of the present disclosure relate generally to wireless communication systems, and more particularly, to resource sharing and allocation among multiple application flows sharing a wireless communication interface.

### BACKGROUND

Wireless communication networks are widely deployed to provide various communication services such as telephony, video, data, messaging, broadcasts, and so on. In modern wireless equipment such as advanced smart phones, several different traffic flows may occur together as the access terminal concurrently runs multiple applications, such as, but not limited to, streaming video, voice over IP, file upload/downloads, email, and Internet browsing. Different types of traffic can have different requirements: in particular, VoIP and streaming video require a relatively high quality of service (QoS). For such traffic, some networks define a QoS management protocol to ensure a good user experience.

In some existing radio access networks, including various WWAN and WLAN technologies, standards bodies have defined and specified QoS management systems capable of managing resource and bandwidth allocation among different application flows, to provide QoS to those applications that need it. However, in most networks deployed today, QoS is infrequently, if ever implemented. Thus, in a network that lacks such QoS management at the radio access network, traffic that would benefit from QoS, such as VoIP and streaming video, may have a somewhat poor user experience.

As the demand for mobile broadband access continues to increase, research and development continue to advance wireless technologies not only to meet the growing demand for mobile broadband access, but to advance and enhance the user experience with mobile communications.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method operable at an access terminal for allocating available bandwidth among a plurality of concurrent application flows. In one example, the method includes reducing a requested bandwidth corresponding to at least one application flow from among the plurality of concurrent application flows if an aggregate requested bandwidth corresponding to the plurality of concurrent application flows is greater than a bandwidth constraint, and maintaining the requested bandwidth for each application flow of the plurality of concurrent application flows if the aggregate requested bandwidth corresponding to the plurality of concurrent application flows is not greater than the bandwidth constraint.

Another aspect of the disclosure provides an access terminal configured for allocating available bandwidth among a plurality of concurrent application flows. In one example, the access terminal includes means for reducing a requested bandwidth corresponding to at least one application flow from among the plurality of concurrent application flows if an aggregate requested bandwidth corresponding to the plurality of concurrent application flows is greater than a bandwidth constraint, and means for maintaining the requested bandwidth for each application flow of the plurality of concurrent application flows if the aggregate requested bandwidth corresponding to the plurality of concurrent application flows is not greater than the bandwidth constraint.

Another aspect of the disclosure provides an access terminal configured for allocating available bandwidth among a plurality of concurrent application flows. In one example, the access terminal includes at least one processor, a memory communicatively coupled to the at least one processor, and a communication interface communicatively coupled to the at least one processor. Further, the at least one processor is configured to reduce a requested bandwidth corresponding to at least one application flow from among the plurality of concurrent application flows if an aggregate requested bandwidth corresponding to the plurality of concurrent application flows is greater than a bandwidth constraint, and to maintain the requested bandwidth for each application flow of the plurality of concurrent application flows if the aggregate requested bandwidth corresponding to the plurality of concurrent application flows is not greater than the bandwidth constraint.

Another aspect of the disclosure provides a computer-readable storage medium at an access terminal configured for allocating available bandwidth among a plurality of concurrent application flows. In one example, the computer-readable storage medium includes instructions for causing a computer to reduce a requested bandwidth corresponding to at least one application flow from among the plurality of concurrent application flows if an aggregate requested bandwidth corresponding to the plurality of concurrent application flows is greater than a bandwidth constraint, and instructions for causing a computer to maintain the requested bandwidth for each application flow of the plurality of concurrent application flows if the aggregate requested bandwidth corresponding to the plurality of concurrent application flows is not greater than the bandwidth constraint.

These and other aspects of the invention will become more fully understood upon a review of the detailed description, which follows.

### BRIEF DESCRIPTION OF THE DRAWINGS

FIG. 1 is a block diagram conceptually illustrating an example of a telecommunications system with a plurality of application flows sharing bandwidth resources in accordance with an aspect of the disclosure.

FIG. 2 is a schematic block diagram further illustrating the sharing of bandwidth resources by plural application flows in accordance with an aspect of the disclosure.

FIG. 3 is a flow chart illustrating a process of allocating shared bandwidth resources among the plural application flows in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

One or more aspects of the disclosure provide apparatus and methods for dynamically allocating bandwidth among different applications running at an access terminal operating in a wireless communication system that may be subject to certain bandwidth constraints. In particular, management of the allocation of resources when such resources are determined to be constrained may be implemented at the access terminal itself. In this way, the superior information available to the access terminal regarding the demands and capabilities of the individual applications can be taken into account. Thus, multiple concurrently running applications competing for common limited resources may achieve a satisfactory level of service or QoS, resulting in an enhanced user experience.

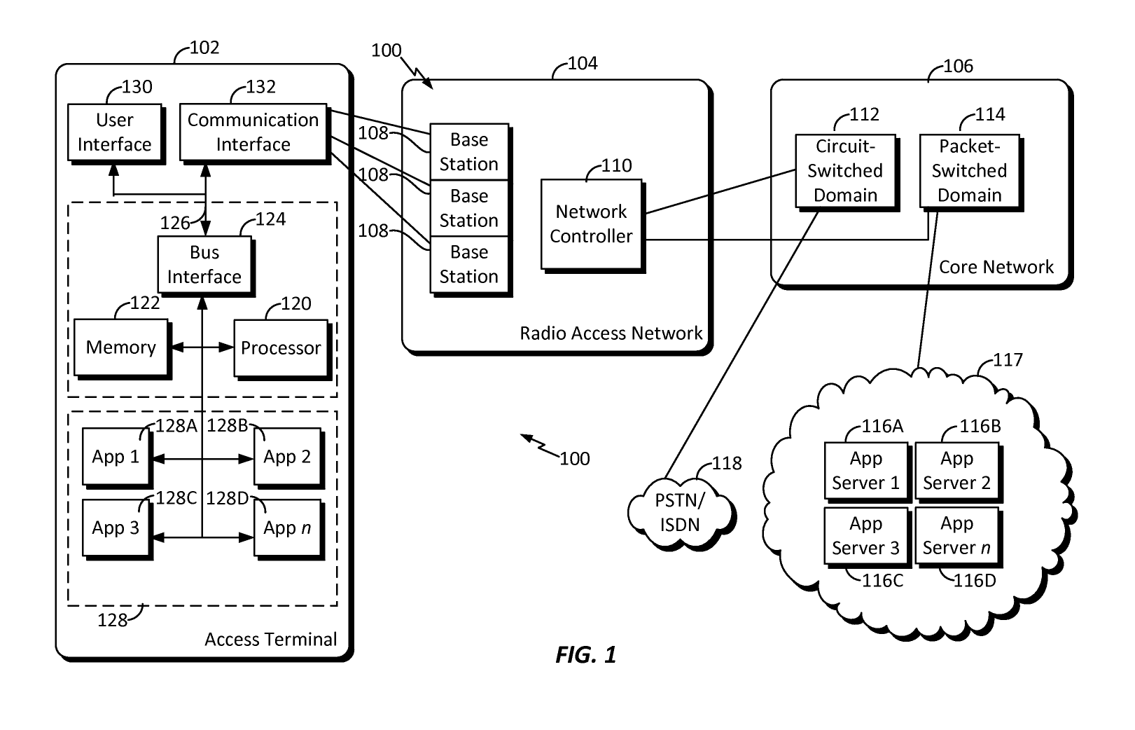

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. Of course, those skilled in the art will comprehend that the illustrated WWAN is but one example, provided for clarity, but the various aspects of the disclosure may be applied to a WLAN, e.g., a home Wi-Fi system where an access terminal communicates with a packet network by way of a wireless access node, utilizing a suitable wireless protocol such as any one defined under the IEEE 802.11 standards.

The illustrated wireless communication system includes three interacting domains: an access terminal 102, a radio access network (RAN) 104, and a core network 106.

Among several options available for the RAN 104, various aspects of the disclosure may utilize one or more communication standards for enabling various wireless services including telephony, video, data, messaging, broadcasts, and/or other services. For example, a RAN may include but is not limited to a GSM/EDGE radio access network (GERAN); a UMTS terrestrial radio access network (UTRAN); an evolved UTRAN (e-UTRAN); an IS-95 or IS-2000 RAN; a WiMAX RAN; or any other suitable RAN.

The RAN 104 may include one or more network controllers 110, such as a radio network controller (RNC) or a base station controller (BSC) (Of course, in the case of an e-UTRAN, the functionality of the network controller 110 resides at the base stations 108). The network controller 110 is generally an apparatus responsible for, among other things, assigning, reconfiguring, and releasing radio resources. The network controller 110 may be interconnected to other network controllers (not shown) in the RAN 104 through various types of interfaces such as a direct physical connection, a virtual network, or the like using any suitable transport network.

The geographic regions covered by the base stations 108 coupled to the network controller 110 may be divided into a number of cells, with a radio transceiver apparatus, i.e., a base station 108 serving each cell. Some examples of a base station may be referred to by those skilled in the art as a Node B, a base transceiver station (BTS), a radio base station, a radio transceiver, a transceiver function, a basic service set (BSS), an extended service set (ESS), an access point (AP), or some other suitable terminology. For clarity, three base stations 108 are shown coupled to the network controller 110; however, the network controller 110 may be coupled to any number of wireless base stations 108.

The base stations 108 provide wireless access points to a core network 106 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. In the present disclosure, for convenience, the mobile apparatus is referred to as an access terminal (AT) 102. However, those of ordinary skill in the art may refer to a mobile apparatus as user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology.

The RAN 104 generally grants a suitable amount of resources (e.g., bandwidth) to the access terminal 102, in accordance with various factors, including but not limited to requests for bandwidth from the access terminal 102; feedback from the access terminal 102 relating to ongoing traffic flows, such as acknowledgements and non-acknowledgements (ACK/NACK) of packets; requests from application servers 116; or other suitable factors.

Further, the RAN 104 may carry many different types of traffic, utilizing corresponding traffic flows between the access terminal 102 and application servers 116. Different types of traffic flows have different requirements, some of which may benefit from a relatively high quality of service (QoS). Although a QoS mechanism has been defined and specified for various RAN technologies, most operators have not implemented such QoS mechanism in currently deployed RANs. Thus, various aspects of the present disclosure implement bandwidth allocation processes at the access terminal 102 itself, in order to improve the quality of experience for a user under constrained bandwidth conditions even when a QoS mechanism is not implemented in a RAN.

The access terminal 102 may include a processing system having one or more processors 120, a memory 122, and a bus interface 108. Examples of processors 120 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system may be implemented with a bus architecture, represented generally by the bus 126. The bus 126 may include any number of interconnecting buses and bridges depending on the specific application of the processing system and the overall design constraints. The bus 126 links together various circuits including one or more processors (represented generally by the processor 120), and a computer-readable medium or memory 122. The bus 126 may also link various other circuits such as timing sources, peripherals, voltage regulators, and power management circuits, which are well known in the art, and therefore, will not be described any further. A bus interface 124 provides an interface between the bus 126 and a communication interface 132. The communication interface 132 provides a means for communicating with various other apparatus over a transmission medium. Depending upon the nature of the apparatus, a user interface 130 (e.g., keypad, display, speaker, microphone, joystick) may also be provided.

The processor 120 is responsible for managing the bus 126 and general processing, including the execution of software stored on the computer-readable medium or memory 122. The software, when executed by the processor 120, causes the processing system to perform the various functions described infra for any particular apparatus. The computer-readable medium or memory 122 may also be used for storing data that is manipulated by the processor 120 when executing software.

One or more processors 120 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium or memory 122. The computer-readable medium or memory 122 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium or memory 122 may reside in the processing system, external to the processing system, or distributed across multiple entities including the processing system. The computer-readable medium or memory 122 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

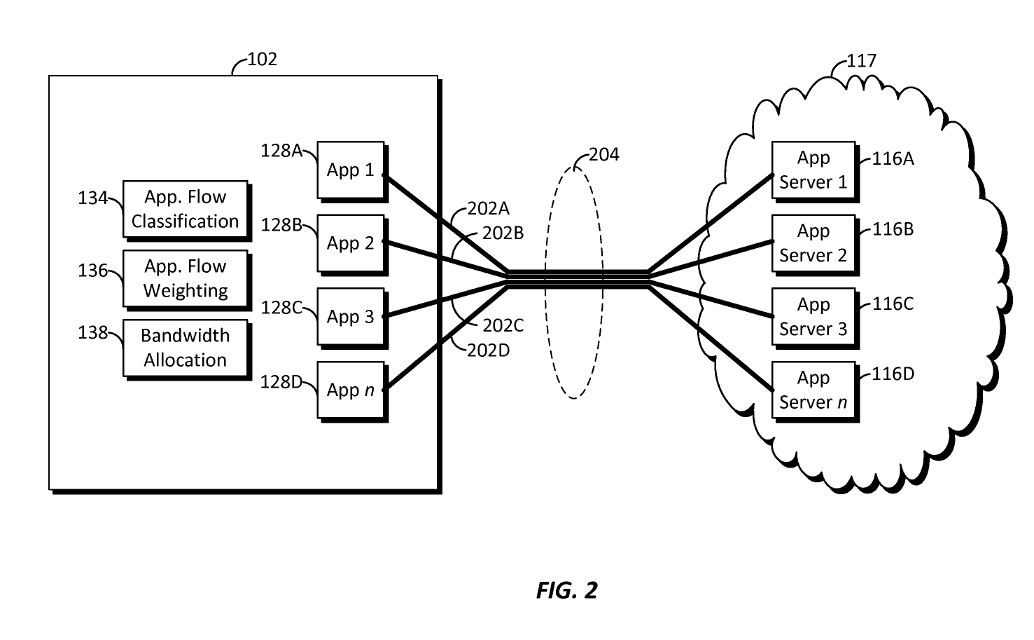

FIG. 2 is a schematic block diagram illustrating portions of the wireless communication system 100 of FIG. 1, including the access terminal 102 and a plurality of application servers 116 within a packet-based network 117. Here, the access terminal 102 is illustrated running a plurality of applications 128A-128D. In the illustration, an application flow 202A-202D is illustrated with a thick line connecting each application 128 with a corresponding application server 116, and the combined bandwidth through which all application flows 202 must pass is illustrated in the dashed oval 204.

In modern access terminals, particularly including smart phones or similar devices, several different applications may coexist, or run concurrently. In the illustrated example, the access terminal 102 includes four applications 128A-128D. Here, an application may be any suitable software-based application, e.g., being stored at the memory 122 or in a separate memory; or in other examples, an application may be dedicated circuitry configured for providing the application functionality to the access terminal 102. Some examples of applications utilizing the communication interface 132 may include streaming video, voice over IP (VoIP), file upload/download, email, Internet browsing, or others. Different types of traffic can have different requirements. In particular, VoIP and streaming video traffic require a relatively high quality of service (QoS) in order to maintain a suitable user experience.

In an aspect of the disclosure, each of the plurality of concurrently running applications 128 may have respective demands for communication traffic utilizing the communication interface 132. Application flows 202 corresponding to each of the concurrently run applications 128, taken together, can sum to an aggregate demand for bandwidth 204 utilizing the communication interface 132. Because, as described above, most RANs lack a QoS mechanism to manage the application flows, when faced with bandwidth constraints the allocation of resources among traffic flows can be poor, resulting in less desirable user experience particularly when utilizing applications that rely on a high QoS.

Thus, in accordance with various aspects of the present disclosure, described in further detail below, the portions of the bandwidth 204 allocated among each application flow 202, and accordingly, allocated among the applications 128 at the access terminal 102, may be dynamically managed by the access terminal 102.

Referring once again to FIG. 1, for illustrative purposes, one access terminal 102 is shown in communication with three base stations 108. The downlink (DL), also called the forward link, refers to the communication link from a base station 108 to an access terminal 102; and the uplink (UL), also called the reverse link, refers to the communication link from the access terminal 102 to a base station 108.

The core network 106 can interface with one or more access networks, such as the RAN 104. The illustrated core network 106 includes a circuit-switched (CS) domain 112 and a packet-switched (PS) domain 114.

In the illustrated example, the circuit-switched domain 112 supports circuit-switched services, providing connectivity between the RAN 104 and a public switched telephone network (PSTN) 118 and, in some examples, an integrated services digital network (ISDN). Thus, when a call is received for a particular access terminal, the core network 106 may determine the access terminal's location and forward the call to the particular RAN serving that location. In some examples, such as an e-UTRA wireless communication system, the circuit-switched domain 112 may be omitted.

The illustrated core network 106 also supports packet-switched data services via the packet-switched domain 114, providing a connection for the RAN 104 to a packet-based network 117. The packet-based network 117 may be the Internet, a private data network, or some other suitable packet-based network.

As illustrated, the packet-based network 117 includes four application servers 116A-116D, although in various examples, any number of application servers 116 may be included in the packet-based network 117. The application servers may include general purpose computers or special-purpose computers, and may be co-located or at disparate locations. Examples of application servers may include an e-mail server, a VoIP server, an FTP server, a streaming video server, a Java application server, a Windows server, a PHP application server, or any other suitable server providing software applications that may be accessed by way of the wireless communication system 100. For example, each application server 116 may be in communication with an application 128 at the access terminal 102. For ease of explanation in the description that follows, it can be assumed that application 1 (128A) at the access terminal 102 is in communication with application server 1 (116A) at the packet-based network 117; application 2 (128B) at the access terminal 102 is in communication with application server 2 (116B) at the packet-based network 117; application 3 (128C) at the access terminal 102 is in communication with application server 3 (116C) at the packet-based network 117; and application n (116D) at the access terminal 102 is in communication with application server n (116D) at the packet-based network 117.

Because, as described above, QoS is typically not implemented in a conventional RAN, an inefficient allocation of resources or bandwidth among multiple competing applications can result. For example, the round trip time (RTT) for packets on various application flows between the access terminal 102 and various application servers 116 may vary, resulting in certain inefficiencies and potentially poor user experience. That is, if an equal share or simple fair share of resources is granted to each concurrently running application, those applications utilizing a traffic flow that would benefit from a high QoS may be inadequately apportioned, being starved of resources, while applications that need not a great allocation of resources, such as an email application, may be unnecessarily granted a large share of the available resources, potentially resulting in a buffer overrun. As an illustrative example, assume a first application is a streaming video application, wherein the user views a movie in real time as its content streams to the access terminal 102 over a first traffic flow utilizing the RAN. Further, assume a second application is a simple file upload/download application. In a scenario wherein these two applications run concurrently and compete for bandwidth, if the aggregate bandwidth available is constrained such that it is less than the demanded bandwidth for the two competing applications, the streaming video application may suffer due to packet losses, higher latency, jitter, etc., leading to a poor user experience.

Therefore, one or more aspects of the disclosure provide for a flexible, dynamic allocation of resources among the application flows 202, operable at the access terminal 102. By utilizing the dynamic allocation operations described herein, and controlling the allocation at the access terminal 102 itself, knowledge of the demands and performance of the concurrently running applications 128 can lead to an improved user experience for applications that benefit from greater bandwidth, while other applications that do not necessarily need the great allocation can be reduced without substantially affecting user experience.

As described below, some aspects of this disclosure relate to three distinct operations that may function in combination to provide an allocation of resources/bandwidth among the concurrently running applications at the access terminal 102. First, each application flow may be classified based on certain characteristics of the respective flows. Second, weights may be assigned to each application flow to enable scaling of the portion of the bandwidth allocated to that flow. And third, utilizing these classifications and weights, an allocation of the total bandwidth is calculated among the concurrent applications.

Thus, an allocation of the bandwidth 204 among the application flows 202 can be achieved by reducing the rate of some or all application flows based on the priority/classifications and/or the weights assigned to the corresponding application, and may be applied individually and by different amounts to each flow 202. Broadly, in the case that the aggregate demand for bandwidth from each application 128 concurrently running at the access terminal 102 exceeds the available bandwidth 204 allocated to the access terminal 102 by the network, one or more aspects of the disclosure provide a way to scale down some or all of those applications' demands, such that any cuts to allocated bandwidth will least affect those applications that would worst affect the user's perception of quality and user experience.

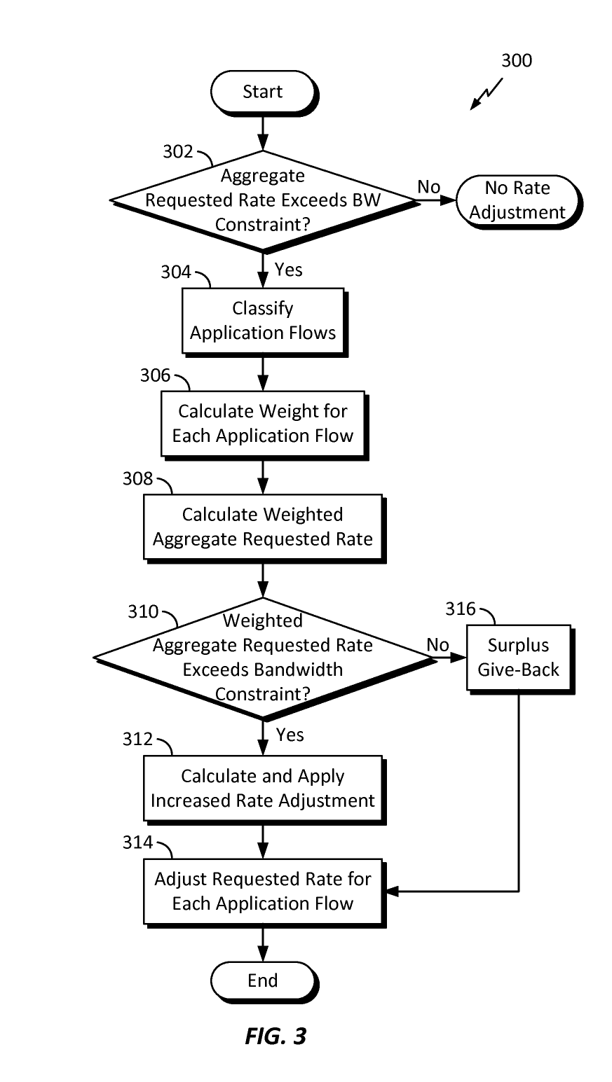

FIG. 3 is a flow chart illustrating an exemplary process 300 of allocating resources among a plurality of applications 128 concurrently running at an access terminal 102 in accordance with an aspect of the disclosure. In some examples, the process 300 may be operable at the access terminal 102, e.g., being stored in memory 122 as a computer program and executed by one or more processors 120 at the access terminal 102.

In various examples, the illustrated process 300 may be implemented upon the occurrence of certain events or triggers. In one example, when the mix of applications or application flows changes, the process 300 may be triggered. That is, if a new application is executed at the access terminal 102, or if a currently running application is terminated at the access terminal 102, because the mix of traffic utilizing the bandwidth 204 has changed, the process 300 may be triggered to determine a new allocation of bandwidth amongst the new mix of applications. In another example, when a bandwidth constraint (i.e., a maximum bandwidth 204 available for use by all applications at the access terminal 102, as described in further detail below). In yet another example, the process 300 may be implemented in accordance with a timer, which may trigger the execution of the process 300 at the access terminal 102 at periodic, regular, or intermittent intervals.

Upon the occurrence of any of these triggers, at the start of the process 300, the access terminal 102 may have a plurality of applications 128 concurrently running, each having a requested rate Rᵢ for communication with a respective application server 116 using corresponding application flows 202. At step 302, the access terminal 102 may determine if an aggregate requested rate R corresponding to all of the applications 202 exceeds a bandwidth constraint.

Here, the aggregate requested rate R may be calculated as:

$$R = {\sum }_{i = 1}^{n} {R}_{i} ,$$

where Rᵢ represents the requested rate corresponding to each application flow i, where there are assumed to be n application flows.

In some examples, wherein one of the concurrently running applications is a voice over LTE application, or other application where the RAN may control QoS, running concurrently with one or more other applications that are not managed by a QoS mechanism, the portion of the total bandwidth allocated for the QoS-controlled flow (e.g., the voice over LTE flow) may be subtracted from the total aggregate requested rate, and one or more aspects of the disclosure may be utilized to allocate the remainder of the total bandwidth among the other concurrently running applications.

Further, a bandwidth constraint R_{c}(t) may correspond to a maximum bandwidth 204 available for use by all applications at the access terminal 102, as predicted by the access terminal 102. In this way, the quality of experience (QoE) of all simultaneously active applications under the bandwidth constraint may be improved or maximized.

That is, the overall bandwidth may be constrained by any one of various static or semi-static parameters of the communication channel, in a similar way to how a chain is only as strong as its weakest link. For example, the overall bandwidth constraint R_{c}(t) may be calculated as the minimum value among one or more potentially constraining parameters, as follows:

R_{c}(t)=min(R_{c}⁽¹⁾,R_{c}⁽²⁾,R_{c}⁽³⁾(t),R_{c}⁽⁴⁾, . . . ).

In this example, R_{c}⁽¹⁾ corresponds to a maximum subscription rate, a static parameter. For example, limitations on backhaul communication rates may be particularly constraining when the base station 108 with which the access terminal 102 communicates is a femtocell.

R_{c}⁽²⁾ corresponds to a network cap for throttling. This may be a static or semi-static parameter.

R_{c}⁽³⁾(t) corresponds to the rate permitted by current radio link conditions. This may be a dynamic parameter, changing with time t. In one example, R_{c}⁽³⁾(t) may be estimated for the uplink and for the downlink from past observations about access terminal data rates.

R_{c}⁽⁴⁾ corresponds to a maximum rate supported by the category, type, or capability of the access terminal 102 (e.g., the hardware and/or software capabilities or limitations of the access terminal 102). This is a static parameter.

Of course, the above-described parameters are only some examples of parameters that may constrain the bandwidth usable by the access terminal 102, and various examples within the scope of the disclosure may have a bandwidth that depends upon only a subset of the above-described parameters, and/or depends upon one or more additional parameters.

Thus, as described above, at step 302 the access terminal 102 may be configured to compare the aggregate of the requested rate R for all concurrently running applications with the bandwidth constraint R_{c}(t).

In some examples, a coefficient of cushioning α (wherein 0≦α≦1) may additionally be applied to the bandwidth constraint R_{c}(t), such that, for example, a new, short-lived application flow may be accommodated without needing to change the rates or weights of existing flows, or to accommodate small fluctuations in the value of R_{c}(t). In some examples, a typical value of α may be about 0.9. Thus, in an aspect of the disclosure, rate adjustment of the various application flows need not be applied in the condition that the aggregate un-weighted requested rate R for all concurrently running applications does not exceed the bandwidth constraint R_{c}(t), scaled by a suitable coefficient of cushioning α. That is:

$${\sum }_{i = 1}^{n} {R}_{i} \leq α {R}_{c} ( t ) .$$

In this condition, where the aggregate requested rate does not exceed the bandwidth constraint, the serviced rate can be the same as the requested rate (i.e., Rᵢ) for each application flow i. That is, no rate adjustment need be applied by the access terminal 102. On the other hand, if the aggregate requested rate exceeds the bandwidth constraint, that is,

$${\sum }_{i = 1}^{n} {R}_{i} > α {R}_{c} ( t ) ,$$

then the process may proceed towards step 304, and undertake to adjust the rate in accordance with the bandwidth constraint.

### Application Flow Classification

At step 304, in an aspect of the disclosure, the access terminal 102 may classify or categorize application flows based on one or more of various criteria, described herein below. Some examples of such criteria that may be utilized for application flow classification include the value of a DSCP field in an IPv4/IPv6 header; a TCP and/or UDP port number; the number of bursts, and the inter-burst interval for the application flow; the average, and/or the variance, of buffer occupancy, throughput, and/or packet size; and specific applications may be detected and accordingly classified, e.g., by packet sniffing. By utilizing these classifications, certain applications for which a user might more readily notice a degradation in bandwidth (e.g., by noticing increased jitter, latency, or other degradation in a streaming video application) may be prioritized above other applications for which a user may not notice such a degradation. In this way, lower priority applications can take a greater hit to their bandwidth than higher priority applications, without substantially affecting user experience.

DSCP

The header of IP packets may include a differentiated services (DiffServ) field, as defined according to IETF RFC 2474. Here, the differentiated services field contains a 6-bit differentiated services code point (DSCP) value. The DSCP value is generally utilized by Internet routers to provide different levels of service to different types of services, such as expedited forwarding to low-loss or low-latency traffic. Thus, in an aspect of the disclosure, the access terminal 102 may read this field, and in accordance with the DSCP value, the access terminal 102 can differentiate between traffic flows that would benefit from greater QoS, such as voice traffic or streaming media traffic, vs. “best-effort” traffic that may not require large allocations of bandwidth.

TCP/UDP Port

When an application 128 sets up a 202 flow for communication with the corresponding application server 116 utilizing one of the transmission control protocol (TCP) or the user datagram protocol (UDP), a corresponding TCP/UDP port is established at the access terminal 102 to serve as a communications endpoint for the traffic flow. In this way, the TCP/UDP port number may be utilized to identify to which application 128 running at the access terminal 102 a particular traffic flow 202 corresponds.

Certain ranges of TCP/UDP port numbers may be utilized for traffic flows utilizing certain protocols. That is, when an application flow is set up utilizing a particular protocol, a TCP/UDP port number may be selected within the corresponding range for that protocol.

Thus, in accordance with an aspect of the disclosure, the TCP/UDP port number for an application flow may utilized for classification of the corresponding application, for allocation of bandwidth among the plural concurrently running applications at the access terminal 102.

Number of Packet Bursts; Inter-Burst Interval

In a further aspect of the disclosure, the access terminal 102 may monitor the number of packet bursts communicated over each application flow 202 within a certain window; and further, the access terminal 102 may monitor the inter-burst interval for each application flow 202. Herein, a “burst” may refer to a substantially continuous flow of packets on an application flow with no significant gap therein. By monitoring the number of bursts and the inter-burst interval, the access terminal 102 may be enabled to differentiate between applications such as Web browsing or instant messaging, which typically utilize multiple bursts having relatively long inter-burst intervals, and applications such as streaming media, which typically utilize single, long bursts. Thereby, applications may be accordingly classified.

Average and/or Variance of Buffer Occupancy

For each application flow, data may be buffered at the access terminal 102, e.g., at the memory 122. In an aspect of the disclosure, the access terminal 102 may determine an average occupancy of the buffer corresponding to each application flow, as well as the variance of this number. In a further aspect of the disclosure, the throughput of an application flow and/or the size of packets in each flow may additionally be monitored by the access terminal 102. These parameters may be utilized for classification of the corresponding application 128.

Packet Sniffing to Detect Specific Applications

In a further aspect of the disclosure, the access terminal 102 may include a packet analyzer or packet sniffer function, configured to detect one or more characteristics of packets traversing each application flow 202. By determining the character of the packets, the access terminal 102 may be enabled to determine a type of traffic, or a type of application causing that traffic. For example, the access terminal 102 may be enabled to determine if an application flow is a VoIP flow or a streaming video flow based on the packet type. Accordingly, applications may be classified according to their packet types.

### Application Flow Weighting

At step 306, in a further aspect of the disclosure, the access terminal 102 may assign each application flow 202 a weight (w), e.g., where 0<w<1. Here, the weight w may be utilized by the access terminal 102 for scaling down the amount of bandwidth allocated to the corresponding flow. For example, the weight may be a multiplication factor to be applied to the allocated bandwidth for an application flow 202, such that as the weight w approaches 1, the application flow 202 approaches the highest priority. In some aspects of the disclosure, the weight w for each application flow may be initialized to a value of 1. Further, the weight w for each application flow may be dynamically updated for each application upon classification of the application, as described above.

The weight w calculated at step 306 may be a function of one or more of various factors or parameters, including but not limited to the application flow type, the data rate, the latency of packets in that flow, or an activity factor. Here, the activity factor corresponds to how long the application 128 runs within a given window.

In some examples, the weight may additionally or alternatively be a function of whether the application 128 is a foreground or background application. For example, foreground applications may have a higher weight assigned than background applications. In this way, applications that the user is more likely to notice can be granted higher priority, and thereby be less likely to be affected by the scaling in such a way as to harm the user experience.

In further examples, the weight may additionally or alternatively be a function of the type of application; e.g., the access terminal 102 may assign streaming video or VoIP applications with higher weights, while the access terminal 102 may assign a file transfer application with a lower weight.

Thus, the rate reduction of each application flow, corresponding to its weight w, generally depends on the priority of the corresponding application, and in general need not be equal for all application flows.

In some cases, such as, for example, where an application flow corresponds to a streaming video application, the application server may utilize an adaptive streaming technique, e.g., being configured to alter one or more characteristics of the transmission when confronted with what it understands to be a reduced available bandwidth (e.g., when it receives fewer or less TCP ACK messages). For example, if the streaming video application were originally transmitting a high-definition video stream such as one adapted for a 1080p display, in the face of reduced ACK messages, the application may reduce the resolution of the display to, say, 720p or some other lesser resolution. In this case, the amount of bandwidth necessary for the lesser resolution video stream may be substantially lower than that required for the higher resolution video stream.

Without taking into account these adaptive streaming techniques, the reduction in the bandwidth that might result from such an adaptation (e.g., the reduction in resolution of a high-definition video stream) may be greater than the requested reduction corresponding to the calculated weight w for that application. Thus, in an aspect of the disclosure, the rate adjustment algorithm may select a weight taking into account the adaptive streaming technique. For example, the weight for a particular application flow may be a non-linear function, taking into account the adaptation of the stream that may occur upon a reduction in the indicated available bandwidth to the corresponding application server (as indicated below).

Thus, at step 308, the access terminal 102 may calculate the weighted or scaled aggregate requested rate. Here, the scaled aggregate service rate for all concurrently running applications may be determined by the access terminal 102 as a sum of the requested rate Rᵢ for each application flow, each multiplied by its respective weight w. For example:

$${R}_{Scaled} = {\sum }_{i = 1}^{n} {w}_{i} {R}_{i} ,$$

wherein Rᵢ represents the requested rate for the i^{th} application flow, which may correspond to a desired quality of experience (QoE); wᵢ represents the weight w for the i^{th} application flow, described above; and n represents the number of applications concurrently operating at the access terminal 102.

The value of Rᵢ may be requested explicitly by each application 128, or in some examples, the access terminal 102 may learn the value of Rᵢ over time for commonly utilized applications.

### Allocation of Bandwidth Among Application Flows

At step 310, in a further aspect of the disclosure, the access terminal 102 may determine whether the weighted aggregate requested R_{Scaled} rate for all concurrently running applications exceeds the bandwidth constraint R_{c}(t), optionally scaled by the coefficient of cushioning α. That is, whether:

$$R = {\sum }_{i = 1}^{n} {w}_{i} {R}_{i} \leq α {R}_{c} ( t ) .$$

That is, even when the calculated weight wᵢ is applied to each application flow i, in an attempt to bring the aggregate weighted requested rate for all concurrently running applications below the bandwidth constraint, it is not necessarily the case that the scaling resulting from the calculated weights wᵢ sufficiently reduces the aggregate requested rate to bring it below the bandwidth constraint.

If, at step 310, it is determined that the weighting does reduce the aggregate requested rate below the bandwidth constraint, then the process may proceed to step 316, wherein a surplus is determined, and given back to the application flows, as described in further detail below.

That is, in some aspects of the disclosure, the weighted rate wᵢRᵢ may be provided for each application flow, as opposed to the requested rate Rᵢ. In this example, the amount of rate reduction ΔRᵢ for each application flow i may be equal to the following:

ΔRᵢ=Rᵢ−wᵢRᵢ=(1−wᵢ)Rᵢ.

And thus, the overall rate reduction ΔR would be equal to the following:

$$Δ R = {\sum }_{i = 1}^{n} Δ {R}_{i} = {\sum }_{i = 1}^{n} ( 1 - {w}_{i} ) {R}_{i} = {\sum }_{i = 1}^{n} {R}_{i} - {\sum }_{i = 1}^{n} {w}_{i} {R}_{i} = {\sum }_{i = 1}^{n} {R}_{i} - R .$$

However, in an aspect of the disclosure, the overall rate reduction ΔR utilizing the calculated weights wᵢ for each application flow, as calculated above, may be greater than necessary, resulting in a scenario wherein the aggregate service rate, as scaled utilizing the calculated weights wᵢ for each application flow, is less than the bandwidth constraint R_{c}. In this case, there may remain a bandwidth surplus, unused by any of the application flows. This surplus is equal to the difference between the scaled bandwidth constraint R_{c}(t) and the scaled aggregate service rate R for all concurrently running applications, as follows:

$$α {R}_{c} ( t ) - {\sum }_{i = 1}^{n} {w}_{i} {R}_{i} .$$

In accordance with an aspect of the disclosure, at step 316, this surplus may be re-allocated back to each of the application flows 202. Here, the amount to re-allocate back to each application flow may be determined in any of several ways. For example, each application flow 202 may receive a portion of the surplus in an amount that corresponds to the weight assigned to each application flow. This surplus give-back ΔR′ may be calculated for each application flow i as follows:

$$Δ {R}_{i}^{′} = \frac{( α {R}_{c} ( t ) - R ) {w}_{i}}{{\sum }_{i = 1}^{n} {w}_{i}} .$$

Thus, the service rate for each application flow i would be equal to wᵢRᵢ+ΔRᵢ′, as opposed to the requested rate Rᵢ. In this case, the overall rate reduction, as compared to the original, un-weighted aggregate requested rate, is as follows:

$${\sum }_{i = 1}^{n} Δ {R}_{i} = {\sum }_{i = 1}^{n} [ ( 1 - {w}_{i} ) {R}_{i} - \frac{( α {R}_{c} ( t ) - R ) {w}_{i}}{{\sum }_{i = 1}^{n} {w}_{i}} ] = {\sum }_{i = 1}^{n} {R}_{i} - α {R}_{c} ( t ) .$$

In some aspects of the disclosure, this surplus may be given back to the various application flows in accordance with a priority assigned to each of the respective flows, which may be determined by the weight w and/or by the classification of each application flow. However, in this case, it is possible that an application may resultingly receive a service rate higher than its requested rate Rᵢ, especially in the case that the weight wᵢ for that application flow is close to 1. Thus, in a further aspect of the disclosure, to reduce or prevent the surplus give-back from causing the service rate from exceeding the requested rate for each application, one or more modified give-back strategies may be utilized, as described below.

For example, rather than applying the give-back utilizing the same priorities as applied for the scaling, in one aspect of the disclosure, the reverse priority may be utilized for the surplus give-back. That is, because a given application with a low priority would have suffered the most in the rate reduction operation due to its low priority, the surplus give-back operation may give higher priority to this application, relieving its suffering to some extent.

In another example, to reduce or prevent the surplus give-back operation from causing the service rate from exceeding the requested rate for an application having a weight w at or near a value of 1, the surplus give-back operation may be applied only for those application flows having a weight wᵢ less than a certain threshold, e.g., 0.9.

In another example, the surplus give-back operation may proceed from the highest priority flow to the lowest, fully fulfilling the demands of each application in turn with the surplus, then taking any residual surplus to the next-highest priority application, and doing the same, until the surplus is fully used. In this way, the highest priority applications may receive their full requested bandwidth, while the resultant scaling may be applied only to the lower priority applications.

If, as described above, an application server 116 utilizes an adaptive streaming technique, such as a streaming video application that might reduce the resolution of a high-definition video stream in accordance with detected available bandwidth, the resulting adaptation may create a bandwidth surplus condition. That is, if a high bandwidth stream makes a reduction to a lesser bandwidth stream (e.g., a 1080p stream being downgraded to a lower resolution video stream such as a 720p stream), the reduced bandwidth needed for this application flow may add to the bandwidth surplus. In an aspect of the disclosure, this bandwidth surplus may be re-allocated back among one or more other application flows as described above.

Returning now to step 310, if the access terminal 102 determines that the weighted aggregate requested rate R_{scaled} still exceeds the bandwidth constraint R_{c}(t) (or, in some examples, the scaled bandwidth constraint), then the process may proceed to step 312, wherein the access terminal 102 may calculate and apply an increased rate adjustment. That is, in the case that:

$${R}_{Scaled} = {\sum }_{i = 1}^{n} {w}_{i} {R}_{i} > α {R}_{c} ( t ) ,$$

then a rate reduction greater than that achieved by utilizing the weight factor w for each application flow may be utilized, in order to ensure that the service rate does not exceed the bandwidth constraint. For example, in an aspect of the disclosure, a rate reduction may take into account the bandwidth constraint R_{c}(t) such that the weighted service rate is less than the bandwidth constraint. Here, the rate reduction ΔR for each application flow i may be determined as follows:

$$Δ {R}_{i} = \frac{( R - α {R}_{c} ( t ) ) ( 1 - {w}_{i} )}{{\sum }_{i = 1}^{n} ( 1 - {w}_{i} )} .$$

Thus, the service rate for each application flow i would be equal to the difference between the requested rate Rᵢ and the rate reduction ΔR, that is, Rᵢ−ΔRᵢ, as opposed to the requested rate Rᵢ. Further, the overall rate reduction relative to the aggregate requested rate would be given as follows:

$${\sum }_{i = 1}^{n} Δ {R}_{i} = {\sum }_{i = 1}^{n} \frac{( R - α {R}_{c} ( t ) ) ( 1 - {w}_{i} )}{{\sum }_{i = 1}^{n} ( 1 - {w}_{i} )} = ( R - α {R}_{c} ( t ) ) = {\sum }_{i = 1}^{n} {w}_{i} {R}_{i} - α {R}_{c} ( t ) .$$

In this example, as seen in the equations above, the rate reduction after the weighting occurs least for the highest priority applications (i.e., those with a w that is close to 1). Of course, this is only one example within the scope of the present disclosure, and other policies, as discussed above, may be applied for rate reduction.

### Implementation of Rate Reduction

Once the amount of rate reduction is determined, in a further aspect of the disclosure, at step 314 the access terminal 102 may utilize one or more of various application flow throttling operations in order to implement the rate reduction for each application flow 202. Here, the way the application flow is throttled depends in part on whether the data is part of an uplink (reverse link) transmission or a downlink (forward link) transmission.

For an application flow corresponding to an uplink transmission, the access terminal 102 may be enabled to utilize memory 122 to queue or buffer the packets from the corresponding application for a suitable length of time, taking the packets out of the queue and transmitting them at the desired, throttled transmission rate. That is, the access terminal 102, utilizing a suitable buffer, can directly control the uplink transmission rate for each application 128 to correspond to a calculated, reduced service rate as described above. This procedure for throttling the data rate can be utilized for essentially any type of flow, including both TCP and UDP flows. If the buffer size allocated by the access terminal 102 for a particular application is not large enough, or if a packet is buffered for too great a length of time, it is possible that some number of packets may be dropped. However, this result, where there is a relatively low risk of packet losses, may be acceptable in comparison to the issues that can affect the application flows when utilizing other allocation operations such as the equal or fair sharing of the bandwidth.

For an application flow corresponding to a downlink transmission, the access terminal 102 may not be capable of directly controlling the transmission rate for each application flow. However, the access terminal 102 may be enabled to utilize one or more indirect mechanisms to result in a throttling of the transmission rate for each application flow. For example, in one aspect of the disclosure, the access terminal 102 may be configured to transmit, on an uplink transmission, an explicit request to the corresponding application server 116 to reduce the data rate in accordance with the calculated reduced bandwidth for that application flow 202. In response, the application server 116 may accordingly control the transmission rate, keeping it at the calculated, reduced rate for that application flow 202.

In another example, particularly applicable to a TCP flow or any other flow that similarly utilizes acknowledgment (ACK) message transmissions in response to received packets that are properly received and decoded, the access terminal 102 may be configured to control the transmission of the ACK packets. For example, the access terminal 102 may reduce the rate of transmission of ACK packets, e.g., by throttling and/or dropping at least a portion of the ACK transmissions to the application server 116, such that the application server 116 may tend to believe that the bandwidth available for the application flow 202 is less than in reality might be available. Here, a flow control algorithm at the application server 116 may accordingly reduce the transmission data rate when it fails to receive an ACK for each transmitted packet in a shorter time. In this way, by placing control on the transmission of ACK messages, the access terminal 102 can be enabled to cause a reduced transmission rate on downlink transmissions corresponding to an application flow originating at the application server 116. In another example, the access terminal 102 may suppress the transmission of ACK messages corresponding to a suitable portion of packets, without necessarily reducing or otherwise modifying the rate of ACK transmissions.

These ACK messages may be operable at any suitable operational layer, such as the application layer, the transport layer (e.g., for TCP ACK messages), or even at a lower layer such as layer 2 HARQ ACK messages. However, in an aspect of the disclosure, the upper layer (e.g., transport layer or application layer) ACK messages may be preferred over the lower layer HARQ ACK messages. That is, the upper layer messages may be directed to the application server 116, such that the individual application server can utilize a flow control algorithm to control the bandwidth utilized by that application. However, lower layer ACK messages are typically directed to the RAN, and may not be specific to a particular application flow 202. Thus, these ACK messages may result in a reduction in the total bandwidth 204 allocated by the RAN 104 for the access terminal 102, which is an undesirable outcome.

In another example, rather than modifying the transmission of ACK messages, the reduction of the requested bandwidth corresponding to an application flow may be achieved by utilizing a reduced-size receive window at one or both of the link layer and/or the transport layer.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method operable at an access terminal for allocating available bandwidth among a plurality of concurrent application flows, the method comprising:
if an aggregate requested bandwidth corresponding to the plurality of concurrent application flows is greater than a bandwidth constraint, reducing a requested bandwidth corresponding to at least one application flow from among the plurality of concurrent application flows; and
if the aggregate requested bandwidth corresponding to the plurality of concurrent application flows is not greater than the bandwidth constraint, maintaining the requested bandwidth for each application flow of the plurality of concurrent application flows.

2. The method of claim 1, wherein the at least one application flow comprises an uplink transmission, and wherein the reducing of the requested bandwidth corresponding to the at least one application flow comprises:
buffering a plurality of packets corresponding to the uplink transmission in a memory at the access terminal; and
transmitting the buffered packets in accordance with the reduced requested bandwidth.

3. The method of claim 1, wherein the at least one application flow comprises a downlink transmission, and wherein the reducing of the requested bandwidth corresponding to the at least one application flow comprises:
reducing a rate of transmission of acknowledgment packets corresponding to the downlink transmission.

4. The method of claim 1, wherein the at least one application flow comprises a downlink transmission, and wherein the reducing of the requested bandwidth corresponding to the at least one application flow comprises:
suppressing a transmission of a portion of acknowledgment packets corresponding to the downlink transmission.

5. The method of claim 1, wherein the at least one application flow comprises a downlink transmission, and wherein the reducing of the requested bandwidth corresponding to the at least one application flow comprises:
reducing a receive window at one or both of a link layer and/or a transport layer.

6. The method of claim 1, wherein the at least one application flow comprises a downlink transmission, and wherein the reducing of the requested bandwidth corresponding to the at least one application flow comprises:
transmitting a request to an application server corresponding to the at least one application flow, the request adapted to request the application server to modify a data rate of the downlink transmission.

7. The method of claim 1, further comprising:
classifying the plurality of concurrent application flows into a plurality of groups, in accordance with factors comprising one or more of: a DSCP field in an IP packet header; a TCP/UDP port number corresponding to each of the plurality of application flows; a number of packet bursts within a first window; an inter-burst interval between the packet bursts within the first window; an average occupancy of a buffer corresponding to each application flow of the plurality of application flows; or a variance in the occupancy of the buffer.

8. The method of claim 1, further comprising:
sniffing packets included in each application flow of the plurality of concurrent application flows; and
classifying the plurality of concurrent application flows in accordance with one or more characteristics of the sniffed packets.

9. The method of claim 1, wherein the bandwidth constraint comprises a minimum value among one or more of a maximum subscription rate, a network data rate cap, a data rate corresponding to radio link conditions, or a maximum data rate supported by a category and/or a capability of the access terminal.

10. The method of claim 9, wherein the bandwidth constraint is further scaled in accordance with a coefficient of cushioning.

11. The method of claim 10, wherein the coefficient of cushioning has a value of about 0.9.

12. The method of claim 1, further comprising:
determining a scaled aggregate requested bandwidth corresponding to the plurality of concurrent application flows, wherein the scaled aggregate requested bandwidth comprises an aggregate of the plurality of concurrent application flows, each application flow scaled by a respective weight,
wherein the weight for each application flow of the plurality of concurrent application flows corresponds to one or more of an application flow type, a data rate, a packet latency, or an activity factor for each respective one of the plurality of concurrent application flows.

13. The method of claim 12, wherein the weight for each application flow of the plurality of concurrent application flows is within a range of 0≦w≦1.

14. The method of claim 12, further comprising:
if the scaled aggregate requested bandwidth corresponding to the plurality of concurrent application flows is less than the bandwidth constraint,
applying the weights to each respective one of the plurality of concurrent application flows;
determining a bandwidth surplus corresponding to a difference between the bandwidth constraint and the scaled aggregate requested bandwidth; and
re-allocating the bandwidth surplus among one or more of the plurality of concurrent application flows in accordance with the weights for each of the respective plurality of concurrent application flows.

15. The method of claim 14, wherein the re-allocating of the bandwidth surplus comprises allocating at least a portion of the bandwidth surplus to a first application flow having a first priority, prior to allocating at least a portion of the bandwidth surplus to a second application flow having a higher priority than the first priority.

16. The method of claim 14, wherein the determining of the bandwidth surplus comprises calculating:
$$Δ {R}_{i}^{′} = \frac{( α {R}_{c} ( t ) - R ) {w}_{i}}{{\sum }_{i = 1}^{n} {w}_{i}} ,$$
wherein:
ΔRᵢ′ is the bandwidth surplus,
α is a coefficient of cushioning,
R_{c}(t) is the bandwidth constraint at time t,
R is the scaled aggregate requested bandwidth corresponding to the plurality of concurrent application flows,
wᵢ is the weight for the i^{th} application flow of the plurality of concurrent application flows, and
n is the number of application flows in the plurality of concurrent application flows; and
wherein the re-allocating of the bandwidth surplus comprises determining a service rate for each application flow among the plurality of concurrent application flows according to the equation wᵢRᵢ+ΔRᵢ′.

17. The method of claim 14, wherein the re-allocating of the bandwidth surplus comprises allocating the bandwidth surplus to the application flows in a reverse order of priority, from lowest priority to highest priority.

18. The method of claim 14, wherein the re-allocating of the bandwidth surplus comprises allocating the bandwidth surplus exclusively among application flows of the plurality of application flows having a weight less than a threshold.

19. The method of claim 18, wherein the threshold is 0.9.

20. The method of claim 14, wherein the re-allocating of the bandwidth surplus comprises allocating the bandwidth surplus to the application flows in order of priority from highest priority to lowest, wherein the allocating comprises fulfilling the requested bandwidth for each application flow in turn from the bandwidth surplus before allocating any portion of the bandwidth surplus to the next application flow.

21. The method of claim 12, further comprising:
if the scaled aggregate requested bandwidth corresponding to the plurality of concurrent application flows is greater than the bandwidth constraint,
determining an increased rate reduction ΔRᵢ according to the equation:
$$Δ {R}_{i} = \frac{( R - α {R}_{c} ( t ) ) ( 1 - {w}_{i} )}{{\sum }_{i = 1}^{n} ( 1 - {w}_{i} )} ,$$
wherein ΔRᵢ is the increased rate reduction applied to application flow i of the plurality of application flows;
R is the scaled aggregate requested bandwidth corresponding to the plurality of concurrent application flows;
R_{c}(t) is the bandwidth constraint at time t;
wᵢ is the weight corresponding to application flow i of the plurality of concurrent application flows;
n is the number of application flows in the plurality of concurrent application flows; and
α is a coefficient of cushioning.

22. The method of claim 12, further comprising:
if the scaled aggregate requested bandwidth corresponding to the plurality of concurrent application flows is greater than the bandwidth constraint, determining an increased rate reduction ΔRᵢ corresponding to each application flow from i to n of the plurality of application flows, wherein n is the number of application flows in the plurality of concurrent application flows,
wherein the increased rate reduction ΔRᵢ is in an amount corresponding to a reverse order of priority, from lowest priority to highest priority.

23. The method of claim 12, further comprising:
if the scaled aggregate requested bandwidth corresponding to the plurality of concurrent application flows is greater than the bandwidth constraint, determining an increased rate reduction ΔRᵢ for application flows of the plurality of application flows having a weight less than a threshold.

24. The method of claim 23, wherein the threshold is 0.9.

25. The method of claim 12, further comprising:
if the scaled aggregate requested bandwidth corresponding to the plurality of concurrent application flows is greater than the bandwidth constraint, determining an increased rate reduction ΔRᵢ corresponding to each application flow from i to n of the plurality of application flows, wherein n is the number of application flows in the plurality of concurrent application flows,
wherein the increased rate reduction ΔRᵢ is in an amount corresponding to an order of priority, from highest priority to lowest priority.

26. The method of claim 1, wherein the at least one application flow corresponds to a video stream.

27. The method of claim 26, wherein the reducing of the requested bandwidth corresponding to the at least one application flow comprises requesting a lesser resolution video stream.

28. An access terminal configured for allocating available bandwidth among a plurality of concurrent application flows, the access terminal comprising:
means for reducing a requested bandwidth corresponding to at least one application flow from among the plurality of concurrent application flows if an aggregate requested bandwidth corresponding to the plurality of concurrent application flows is greater than a bandwidth constraint; and
means for maintaining the requested bandwidth for each application flow of the plurality of concurrent application flows if the aggregate requested bandwidth corresponding to the plurality of concurrent application flows is not greater than the bandwidth constraint.

29. The access terminal of claim 28, wherein the bandwidth constraint comprises a minimum value among one or more of a maximum subscription rate, a network data rate cap, a data rate corresponding to radio link conditions, or a maximum data rate supported by a category and/or a capability of the access terminal.

30. The access terminal of claim 28, further comprising:
means for determining a scaled aggregate requested bandwidth corresponding to the plurality of concurrent application flows, wherein the scaled aggregate requested bandwidth comprises an aggregate of the plurality of concurrent application flows, each application flow scaled by a respective weight,
wherein the weight for each application flow of the plurality of concurrent application flows corresponds to one or more of an application flow type, a data rate, a packet latency, or an activity factor for each respective one of the plurality of concurrent application flows.

31. The access terminal of claim 30, further comprising:
if the scaled aggregate requested bandwidth corresponding to the plurality of concurrent application flows is less than the bandwidth constraint,
means for applying the weights to each respective one of the plurality of concurrent application flows;
means for determining a bandwidth surplus corresponding to a difference between the bandwidth constraint and the scaled aggregate requested bandwidth; and
means for re-allocating the bandwidth surplus among one or more of the plurality of concurrent application flows in accordance with the weights for each of the respective plurality of concurrent application flows.

32. The access terminal of claim 28, wherein the at least one application flow corresponds to a video stream.

33. The access terminal of claim 32, wherein the means for reducing the requested bandwidth corresponding to the at least one application flow is configured to request a lesser resolution video stream.

34. An access terminal configured for allocating available bandwidth among a plurality of concurrent application flows, the access terminal comprising:
at least one processor;
a memory communicatively coupled to the at least one processor; and
a communication interface communicatively coupled to the at least one processor,
wherein the at least one processor is configured to:
reduce a requested bandwidth corresponding to at least one application flow from among the plurality of concurrent application flows if an aggregate requested bandwidth corresponding to the plurality of concurrent application flows is greater than a bandwidth constraint; and
maintain the requested bandwidth for each application flow of the plurality of concurrent application flows if the aggregate requested bandwidth corresponding to the plurality of concurrent application flows is not greater than the bandwidth constraint.

35. The access terminal of claim 34, wherein the bandwidth constraint comprises a minimum value among one or more of a maximum subscription rate, a network data rate cap, a data rate corresponding to radio link conditions, or a maximum data rate supported by a category and/or a capability of the access terminal.

36. The access terminal of claim 34, wherein the at least one processor is further configured to:
determine a scaled aggregate requested bandwidth corresponding to the plurality of concurrent application flows, wherein the scaled aggregate requested bandwidth comprises an aggregate of the plurality of concurrent application flows, each application flow scaled by a respective weight,
wherein the weight for each application flow of the plurality of concurrent application flows corresponds to one or more of an application flow type, a data rate, a packet latency, or an activity factor for each respective one of the plurality of concurrent application flows.

37. The access terminal of claim 36, wherein the at least one processor is further configured to:
if the scaled aggregate requested bandwidth corresponding to the plurality of concurrent application flows is less than the bandwidth constraint,
apply the weights to each respective one of the plurality of concurrent application flows;
determine a bandwidth surplus corresponding to a difference between the bandwidth constraint and the scaled aggregate requested bandwidth; and
re-allocate the bandwidth surplus among one or more of the plurality of concurrent application flows in accordance with the weights for each of the respective plurality of concurrent application flows.

38. The access terminal of claim 34, wherein the at least one application flow corresponds to a video stream.

39. The access terminal of claim 38, wherein the at least one processor, being configured to reduce the requested bandwidth corresponding to the at least one application flow, is further configured to request a lesser resolution video stream.

40. A computer-readable storage medium at an access terminal configured for allocating available bandwidth among a plurality of concurrent application flows, the computer-readable storage medium comprising:
instructions for causing a computer to reduce a requested bandwidth corresponding to at least one application flow from among the plurality of concurrent application flows if an aggregate requested bandwidth corresponding to the plurality of concurrent application flows is greater than a bandwidth constraint; and
instructions for causing a computer to maintain the requested bandwidth for each application flow of the plurality of concurrent application flows if the aggregate requested bandwidth corresponding to the plurality of concurrent application flows is not greater than the bandwidth constraint.

41. The computer-readable storage medium of claim 40, wherein the bandwidth constraint comprises a minimum value among one or more of a maximum subscription rate, a network data rate cap, a data rate corresponding to radio link conditions, or a maximum data rate supported by a category and/or a capability of the access terminal.

42. The computer-readable storage medium of claim 40, further comprising:
instructions for causing a computer to determine a scaled aggregate requested bandwidth corresponding to the plurality of concurrent application flows, wherein the scaled aggregate requested bandwidth comprises an aggregate of the plurality of concurrent application flows, each application flow scaled by a respective weight,
wherein the weight for each application flow of the plurality of concurrent application flows corresponds to one or more of an application flow type, a data rate, a packet latency, or an activity factor for each respective one of the plurality of concurrent application flows.

43. The computer-readable storage medium of claim 42, further comprising:
if the scaled aggregate requested bandwidth corresponding to the plurality of concurrent application flows is less than the bandwidth constraint,
instructions for causing a computer to apply the weights to each respective one of the plurality of concurrent application flows;
instructions for causing a computer to determine a bandwidth surplus corresponding to a difference between the bandwidth constraint and the scaled aggregate requested bandwidth; and
instructions for causing a computer to re-allocate the bandwidth surplus among one or more of the plurality of concurrent application flows in accordance with the weights for each of the respective plurality of concurrent application flows.

44. The computer-readable storage medium of claim 40, wherein the at least one application flow corresponds to a video stream.

45. The computer-readable storage medium of claim 44, wherein the instructions for causing a computer to reduce the requested bandwidth corresponding to the at least one application flow are further configured to request a lesser resolution video stream.
